(19) United States
(12) Patent Application Publication
(10) Pub. No.: US 2012/0132730 A1
(43) Pub. Date: May 31, 2012

(54) Enhanced Nozzle Body

(75) Inventors: John Peterson, Jackson, MN (US); Kevin Mcllravy, Maddock, ND (US)

(73) Assignee: AGCO Corporation, Duluth, GA (US)

(21) Appl. No.: 12/956,201

(22) Filed: Nov. 30, 2010

(51) Int. Cl. A01G 25/09; B05B 3/04

(52) U.S. Cl. 239/738

(57) ABSTRACT

A nozzle body may be provided. The nozzle body may comprise a flow path and a vent. The flow path may be configured to provide an open channel for a fluid between a lower portion of a pipe and at least one outlet. The vent may be configured to vent a gas in an upper portion of the pipe to the flow path.

### BACKGROUND

A sprayer is a device used to spray a liquid. In agriculture, a sprayer is a piece of equipment that applies herbicides, pesticides, and fertilizers to agricultural crops. Sprayers range in size from man-portable units (typically backpacks with spray guns) to self-propelled units similar to tractors, with boom mounts of 60-151 feet in length.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

A nozzle body may be provided. The nozzle body may comprise a flow path and a vent. The flow path may be configured to provide an open channel for a fluid between a lower portion of a pipe and at least one outlet. The vent may be configured to vent a gas in an upper portion of the pipe to the flow path.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 shows a crop sprayer;

FIG. 2 shows a fluid delivery system;

FIG. 3 shows a nozzle body; and

FIG. 4 shows a cross section of the nozzle body shown in FIG. 3.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention.

A crop sprayer sprays herbicides, pesticides, and fertilizers on agricultural crops in a field. With conventional crop sprayers, an operator may start a pump and begin to drive the crop sprayer forward in a field. However, fluid may not spray from the crop sprayer for some distance until a gas in the crop sprayer's plumbing compresses. This may be troublesome because a portion of the field traversed while the gas is being compressed may not receive any fluid. Similarly, the operator may stop the pump and stop driving the crop sprayer forward in the field. In this situation, the fluid may continue to spray from the crop sprayer for some time until the gas in the crop sprayer's plumbing becomes un-compressed even though the pump and the crop sprayer have stop. This may be troublesome because the fluid sprayed while the crop sprayer has stopped and waiting for the gas to un-compress may be wasted.

Consistent with embodiments of the invention, an enhanced nozzle body may be provided with a vent. This enhanced nozzle body, consistent with embodiments of the invention, may provide a more direct relationship between turning the pump on and off and the starting and stopping of the fluid spray.

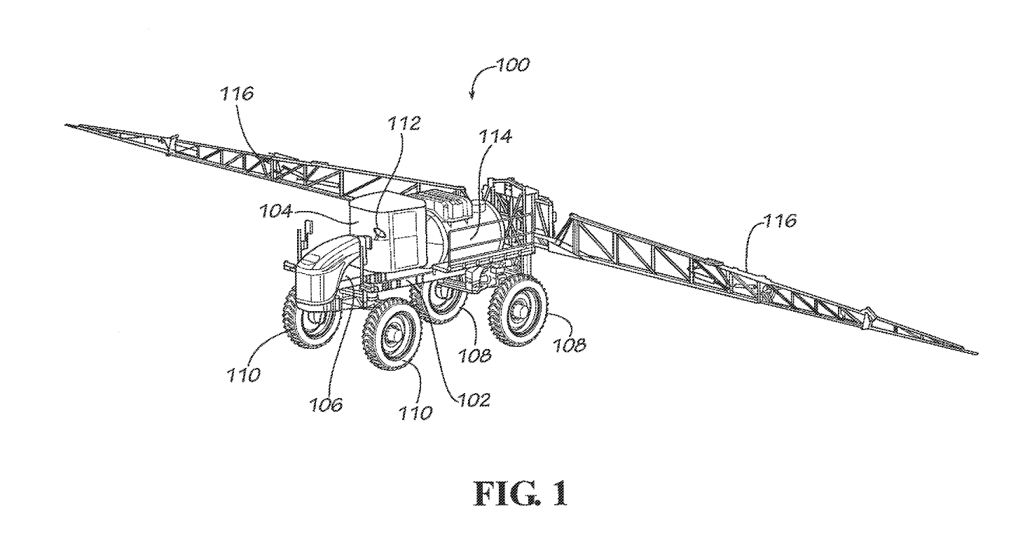

FIG. 1 shows a crop sprayer 100. Crop sprayer 100 may include a frame 102. Frame 102 may be of unitary construction or may include one or more pieces secured together. Frame 102 may comprise a support frame that may span crop sprayer 100's length and may provide a structure for mounting other crop sprayer 100's components. Crop sprayer 100 may also include a cab 104 mounted on frame 102. Cab 104 may houses an operator and a number of controls for crop sprayer 100.

An engine 106 may be mounted on a forward portion of frame 102 in front of cab 104 or may be mounted on a rearward portion of frame 102 behind cab 104. Engine 106 may be commercially available from a variety of sources and may comprise, for example, a diesel engine or may be a gasoline powered internal combustion engine. Engine 106 may be used to provide energy to propel crop sprayer 100 and may provide energy used to spray fluids from crop sprayer 100.

Frame 102 may be supported by a pair of rear wheels 108 and a pair of front wheels 110. Rear wheels 108 may be driven by engine 106 so as to propel crop sprayer 100. In particular, engine 106 may generate mechanical energy that may be transferred to rear wheels 108 by a transmission (not shown), drive shaft (not shown), and rear differential (not shown). Front wheels 110 may be operable to steer crop sprayer 100.

Crop sprayer 100's propulsion and direction may be controlled by one or more operator controls that include, but are not limited to, an accelerator (not shown), a brake (not shown), and a steering wheel 112. Alternatively, crop sprayer 100's propulsion may be integrated into a control handle (not shown). For example, the operator may push the control handle forward to increase crop sprayer 100's speed and may pull back the control handle to decrease crop sprayer 100's speed.

Crop sprayer 100 may further include a storage tank 114 that may be used to store a fluid to be sprayed on a field. The fluid may include chemicals, such as but not limited to, herbicides, pesticides, or fertilizers. Storage tank 114 may be mounted on frame 102, either in front of or behind cab 104. Crop sprayer 100 may include more than one storage tank 114 to store different chemicals to be sprayed on the field. The stored chemicals may be dispersed by crop sprayer 100 one at a time or different chemicals may be mixed and dispersed together in a variety of mixtures.

Crop sprayer 100 may further include a boom arm 116 that may be operable to distribute the fluid over a wide swath in the field. As will be described in greater detail below, a plurality of nozzles may be spaced along boom arm 116 through which the fluid may be sprayed as crop sprayer 100 is driven forward in the field to distribute the chemicals onto crops in the field. Crop sprayer 100's operator may use the control handle, located in cab 104, to control boom arm 116's location and the fluid dispersion through the nozzles. The operator may use the control handle to turn on the fluid flow to the plurality of nozzles and to shut off the fluid flow to the plurality of nozzles.

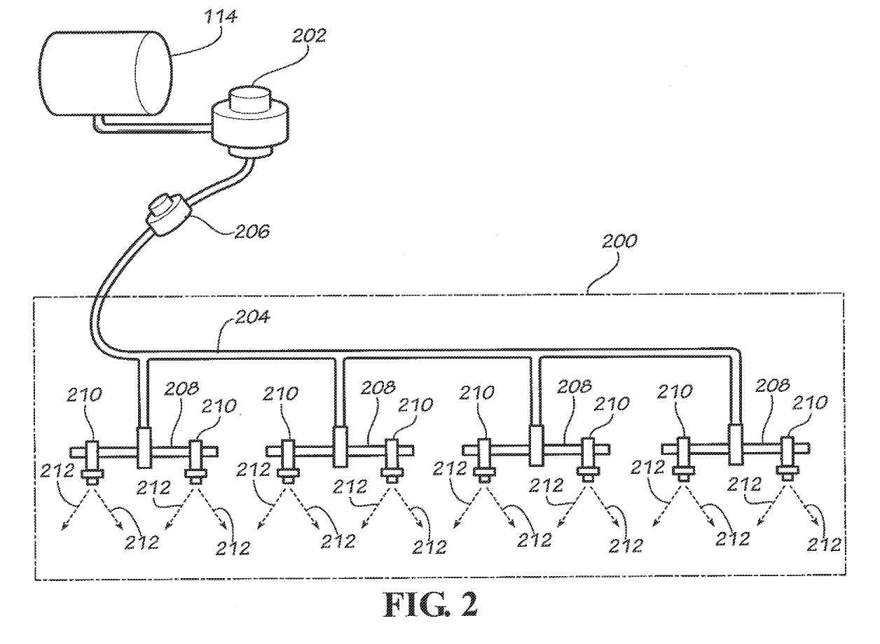

FIG. 2 shows a fluid delivery system 200. As shown in FIG. 2, a pump 202, which may be mounted on frame 102, may pump the fluid from tank 114 into hose 204. (Pump 202 may also be mounted inside tank 114 and submersed in tank 114's fluid.) A valve 206 may be used to control the fluid's flow in hose 204. Pump 202 and valve 206 may be controlled by crop sprayer 100's operator located in cab 104.

From hose 204, the fluid may flow into a plurality of pipes 208. A plurality of nozzle bodies 210 may be mounted to each pipe 208. From each pipe 208, the fluid may flow from pipe 208 to each nozzle body 210. From each nozzle body 210 the fluid may be sprayed as illustrated by directional arrows 212. Fluid delivery system 200 may be mounted on boom arm 116. Nozzle bodies 210 may be spaced along boom arm 116 through which the fluid may be sprayed as crop sprayer 100 is driven forward in the field to distribute chemicals onto crops in the field.

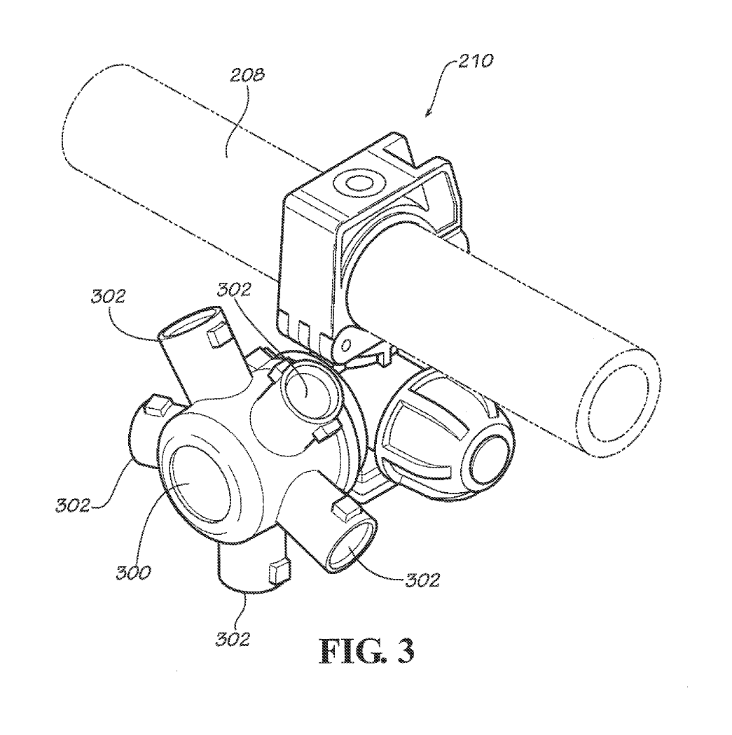

FIG. 3 shows nozzle body 210 from FIG. 2 in more detail. As shown in FIG. 3, nozzle body 210 may include a rotor 300. Rotor 300 may include a plurality of outlets 302. As the fluid passes from pipe 208 into nozzle body 210, the fluid may exit nozzle body 210 from plurality of outlets 302. As the fluid exits outlets 302, rotor 300 may rotate. Rotor 300's rotation may create a spray out of the fluid exiting plurality of outlets 302. Rotor 300's rotation may be caused by the fluid's pressure as it passes into rotor 300.

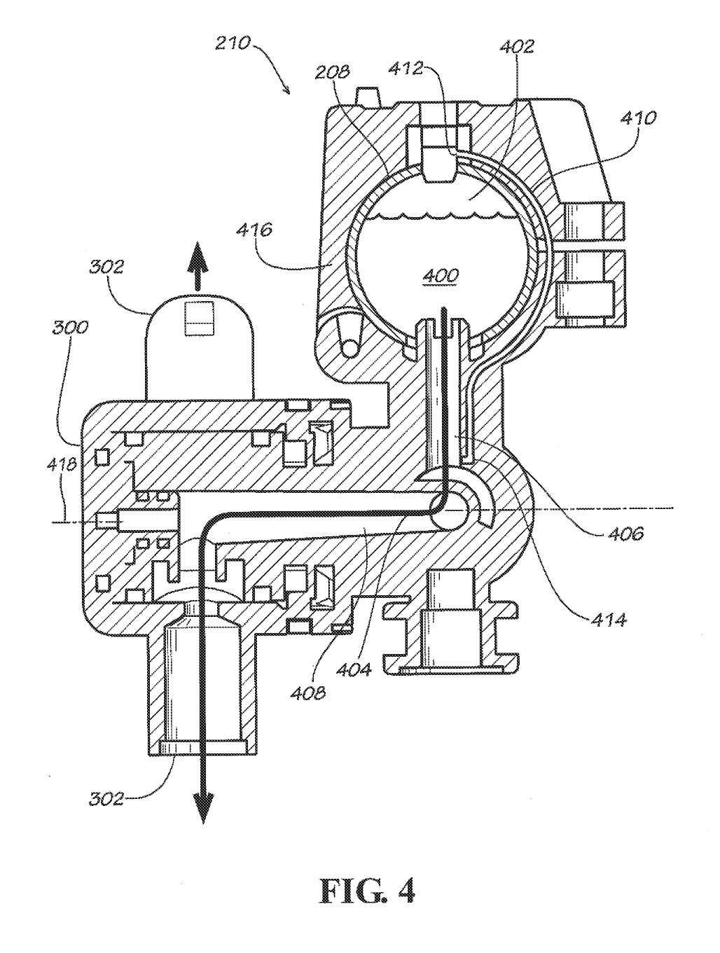

FIG. 4 shows a cross section of nozzle body 210 shown in FIG. 3. Nozzle body 210 may fasten snuggly around pipe 208. Pipe 208 may contain a fluid 400 from tank 114 in a lower portion of pipe 208 and a gas 402 (e.g. air) in an upper portion of pipe 208. In other words, the upper portion of pipe 208 may be that portion of pipe 208 containing gas 402 and the lower portion of pipe 208 may be that portion of pipe 208 containing fluid 400. As shown in FIG. 4, nozzle body 210 may comprise a flow path 404 through which fluid 400 may flow. Flow path 404 may comprise a standpipe 406, a nozzle pathway 408, and outlets 302.

Pump 202 may pump fluid 400 from tank 114 and into pipe 208. From pipe 208, fluid 400 may flow from the lower portion of pipe 208, through standpipe 406, through nozzle pathway 408, into rotor 300, and out outlets 302. Flow path 404 may be configured to provide an open channel between the lower portion of pipe 208 and at least one of the outlets 302 for fluid 400's flow. Standpipe 406 and nozzle pathway 408 may be substantially perpendicular.

Consistent with embodiments of the invention, a vent 410 may be configured to vent gas 402, in the upper portion of pipe 208, to flow path 404. Vent 410 may comprise, for example, a tube, a hose, a pipe, a channel molded into nozzle body 210, or any element capable of venting gas 402 to flow path 404. Vent 410 may comprise an upper orifice 412 and a lower orifice 414. Upper orifice 412 may be open to the upper portion of pipe 208 containing gas 402 and lower orifice 414 may be open to flow path 404.

Standpipe 406 may have an upper end and a lower end. The upper end of standpipe 406 may connect to pipe 208. The upper end of standpipe 406 may protrude into pipe 208 or may be flush with an inside wall of pipe 208. Notwithstanding, an orifice at the upper end of standpipe 406 may be open to the lower portion of pipe 208. The lower end of standpipe 406 may connect to a first end of nozzle pathway 408. A second end of nozzle pathway 408 may connect to rotor 300 thus completing flow path 404 from the lower portion of pipe 208 to outlets 302. Moreover, nozzle body 210 may have a nozzle body upper portion 416 configured to fasten snuggly around pipe 208.

As fluid 400 exits outlets 302, rotor 300 may rotate about axis 418. Axis 418 may be substantially perpendicular to standpipe 406. Rotor 300's rotation may create a spray out of fluid 400 exiting outlets 302. Rotor 300's rotation may be caused by fluid 400's pressure as it passes into rotor 300.

If vent 410 were not present in nozzle body 210, when pump 202 pumps fluid 400 from tank 114 and into pipe 208, gas 402 may begin to compress. Once gas 402 has been compressed and stasis is reached, fluid 400 may begin to flow in flow path 404. Similarly, even when pump 202 stops pumping fluid 400 from tank 114 and into pipe 208, compressed gas 402 may still cause fluid 400 to continue to flow through nozzle body 210 until stasis is reached.

This gas compression process in conventional systems may be troublesome because starting and stopping the fluid flow from nozzle body 210 may not be controlled by turning pump 202 on and off respectively. In other words, there may be a time delay between turning pump 202 on and the start of fluid flow out of outlets 302. This time delay may comprise the time for gas 402 in pipe 208 to compress and stasis to be reached. Similarly, there may be a time delay between turning pump 202 off and the cessation of fluid flow out of outlets 302. This time delay may comprise the time for gas 402 in pipe 208 to become un-compress and stasis to be reached.

For example, the operator in cab 104 may start pump 202 and drive crop sprayer 100 forward in the field. However, the fluid may not begin to be sprayed from crop sprayer 100 for some distance until gas 402 has become compressed. Furthermore, the operator in cab 104 may stop pump 202 and stop driving crop sprayer 100 forward in the field. However, the fluid may continue to be sprayed from crop sprayer 100 for some time until gas 402 has become un-compressed even though pump 202 (and crop sprayer 100) has stop. Consistent with embodiments of the invention, by providing nozzle body 210 with vent 410 for example, a more direct relationship may be realized between turning pump 202 on and off and the starting and stopping of the fluid flow from nozzle body 210.

While certain embodiments of the invention have been described, other embodiments may exist. Further, any disclosed methods' stages may be modified in any manner, including by reordering stages and/or inserting or deleting stages, without departing from the invention. While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A nozzle body comprising:
a flow path for a fluid, the flow path configured to provide an open channel between a lower portion of a pipe and at least one outlet; and
a vent configured to vent a gas in an upper portion of the pipe to the flow path.

2. The nozzle body of claim 1, wherein the flow path comprises a standpipe comprising an upper end having an upper end standpipe orifice open to the lower portion of the pipe.

3. The nozzle body of claim 2, wherein a portion of the upper end of the standpipe protrudes into the lower portion of the pipe.

4. The nozzle body of claim 2, wherein the flow path comprises a nozzle pathway connecting a lower end of the standpipe to the at least one outlet.

5. The nozzle body of claim 4, wherein the nozzle pathway and the standpipe are substantially perpendicular.

6. The nozzle body of claim 1, wherein the vent configured to vent the gas in the upper portion of the pipe to the flow path comprises the vent configured to vent the gas in the upper portion of the pipe to a standpipe in the flow path.

7. The nozzle body of claim 1, wherein the vent configured to vent the gas in the upper portion of the pipe to the flow path comprises the vent configured to vent the gas in the upper portion of the pipe to a nozzle pathway in the flow path.

8. The nozzle body of claim 1, wherein the vent comprises a channel molded into the nozzle body.

9. The nozzle body of claim 1, further comprising a rotor including the at least one outlet.

10. The nozzle body of claim 9, wherein the rotor is configured to rotate when the fluid passes through the flow path and out the at least one outlet.

11. The nozzle body of claim 9, wherein the rotor is configured to rotate about an axis substantially perpendicular to a standpipe in the flow path.

12. The nozzle body of claim 1, further comprising an upper portion configured to fit snuggly around the pipe.

13. A nozzle body comprising:
a flow path for a fluid, the flow path configured to provide an open channel between a lower portion of a pipe and at least one outlet wherein the flow path comprises;
a standpipe comprising an upper end having an upper end standpipe orifice open to the lower portion of the pipe wherein a portion of the upper end of the standpipe protrudes into the lower portion of the pipe, and
a nozzle pathway connecting a lower end of the standpipe to the at least one outlet wherein the nozzle pathway and the standpipe are substantially perpendicular; and
a vent configured to vent a gas in an upper portion of the pipe to the flow path.

14. The nozzle body of claim 13, wherein the vent configured to vent the gas in the upper portion of the pipe to the flow path comprises the vent configured to vent the gas in the upper portion of the pipe to a standpipe in the flow path.

15. The nozzle body of claim 13, wherein the vent configured to vent the gas in the upper portion of the pipe to the flow path comprises the vent configured to vent the gas in the upper portion of the pipe to a nozzle pathway in the flow path.

16. The nozzle body of claim 13, wherein the vent comprises a channel molded into the nozzle body.

17. The nozzle body of claim 13, further comprising a rotor including the at least one outlet.

18. The nozzle body of claim 17, wherein the rotor is configured to rotate when the fluid passes through the flow path and out the at least one outlet wherein the rotor is configured to rotate about an axis substantially perpendicular to the standpipe.

19. The nozzle body of claim 13, further comprising an upper portion configured to fit snuggly around the pipe.

20. A nozzle body comprising:
an upper portion configured to fit snuggly around a pipe;
a flow path for a fluid, the flow path configured to provide an open channel between a lower portion of the pipe and a plurality of outlets wherein the flow path comprises;
a standpipe comprising an upper end having an upper end standpipe orifice open to the lower portion of the pipe wherein a portion of the upper end of the standpipe protrudes into the lower portion of the pipe, and
a nozzle pathway connecting a lower end of the standpipe to the plurality of outlets wherein the nozzle pathway and the standpipe are substantially perpendicular;
a vent configured to vent a gas in an upper portion of the pipe to the flow path wherein the vent configured to vent the gas in the upper portion of the pipe to the flow path comprises the vent configured to vent the gas in the upper portion of the pipe to one of the following: the standpipe in the flow path and the nozzle pathway in the flow path, the vent comprises a channel molded into nozzle body; and
a rotor including the plurality of outlets wherein the rotor is configured to rotate when the fluid passes through the flow path and out the plurality of outlets wherein the rotor is configured to rotate about an axis substantially perpendicular to the standpipe.
